(19) United States
(12) Patent Application Publication
(10) Pub. No.: US 2013/0111041 A1
(43) Pub. Date: May 2, 2013

(54) ESTABLISHING A CONNECTION WITH A USER DEVICE

(71) Applicants: Banavara Madhusudan, Bangalore Karnataka (IN); Alan C. Berkema, Granite Bay, CA (US)

(72) Inventors: Banavara Madhusudan, Bangalore Karnataka (IN); Alan C. Berkema, Granite Bay, CA (US)

(21) Appl. No.: 13/284,608

(22) Filed: Oct. 28, 2011

(51) Int. Cl. G06F 15/16

(52) U.S. Cl. 709/227

(57) ABSTRACT

A method performed by a first user device includes broadcasting first user information using a wireless interface of the first user device and establishing a direct data-link layer connection with a second user device using the wireless interface in response to receiving second user information from the second user device.

### BACKGROUND

User devices often include wireless communication technology that allows users to connect to Wireless Local Area Networks (WLAN). A WLAN includes a number of devices that are connected to each other over a wireless network. To use a wireless network, a user device generally establishes a connection with the network by associating with the network. The association process may include selecting a network to access and performing any authentication steps defined by the network. Once associated with a network, a user device may determine whether communication with other devices connected to the network is desired.

### BRIEF DESCRIPTION OF THE DRAWINGS

FIG. 1 is a block diagram illustrating one embodiment of a user information exchange environment.

FIGS. 2A-2B are schematic diagrams illustrating embodiments of user information exchanges between user devices.

FIG. 3 is a block diagram illustrating one embodiment of a network packet that includes user information.

FIGS. 4A-4B are flow charts illustrating embodiments of methods for establishing direct data-link layer connections.

FIG. 5 is a flow chart illustrating an embodiment of a method for broadcasting user information in response to a solicitation.

### DETAILED DESCRIPTION

In the following detailed description, reference is made to the accompanying drawings, which form a part hereof, and in which is shown by way of illustration specific embodiments in which the disclosed subject matter may be practiced. It is to be understood that other embodiments may be utilized and structural or logical changes may be made without departing from the scope of the present disclosure. The following detailed description, therefore, is not to be taken in a limiting sense, and the scope of the present disclosure is defined by the appended claims.

As described herein, a user information exchange environment is provided that allows user devices to exchange user information and establish a direct data-link layer connection. The user information includes information that identifies a user of a user device such as a name, an address, a phone number, an email address, a social networking identifier, a business loyalty program identifier, an affiliation, a membership, and/or a temporary or limited use identifier. An application on the user device allows a user to provide user information and configure settings, such as security settings, that determine when the user information may be transmitted to other user devices. The user information exchange environment may enable wireless titer discovery and location-based social networking interaction, targeted service delivery, and service logistics management.

An initiating user device may begin a user information exchange by wirelessly broadcasting user information or a solicitation for user information from other user devices. A receiving user device that receives broadcast user information or a solicitation for user information may respond by transmitting user information from the receiving user device in accordance with the user settings of the receiving user device. The receiving user device may also ignore the received user information or solicitation or verify the source of the received user information using security protocols before transmitting user information. When user information is exchanged or a solicitation is accepted, the initiating and receiving user devices may establish a direct data-link layer connection. The initial communications between the user devices may be accomplished using Generic Advertisement Services (GAS) exchanges or customized packet frames.

As used herein, the term broadcast refers to a transmission of data over a wireless interface without specifying a network as a destination. A broadcast may be directed at or intended for any suitable number of other user devices. A broadcast that is directed at or intended for a defined set of two or more user devices is referred to herein as a multicast, and a broadcast that is directed at or intended for a single user device is referred to herein as a unicast.

After the user devices establish the connection, communication between the devices occurs on the data-link layer of the Open Systems Interconnect (OSI) networking model. The data-link layer defines the various protocols used to transfer data between two points within the same Local Area Network (LAN). The data-link layer connection is referred to herein as a level 2 connection. The data-link layer connection essentially represents a new LAN that consists of only the user devices. Various security protocols may be used by the user devices.

As used herein, the term “direct connection”, “direct data-link layer connection”, and “direct level 2 connection” refer to a connection that involves protocols used by the data-link layer of the OSI networking model. In addition, establishing a direct connection, a direct data-link layer connection, or a direct level 2 connection may simply involve an exchange of data between user devices. Establishing a direct connection, a direct data-link layer connection, or a direct level 2 connection does not involve associating with a network as described in additional detail below.

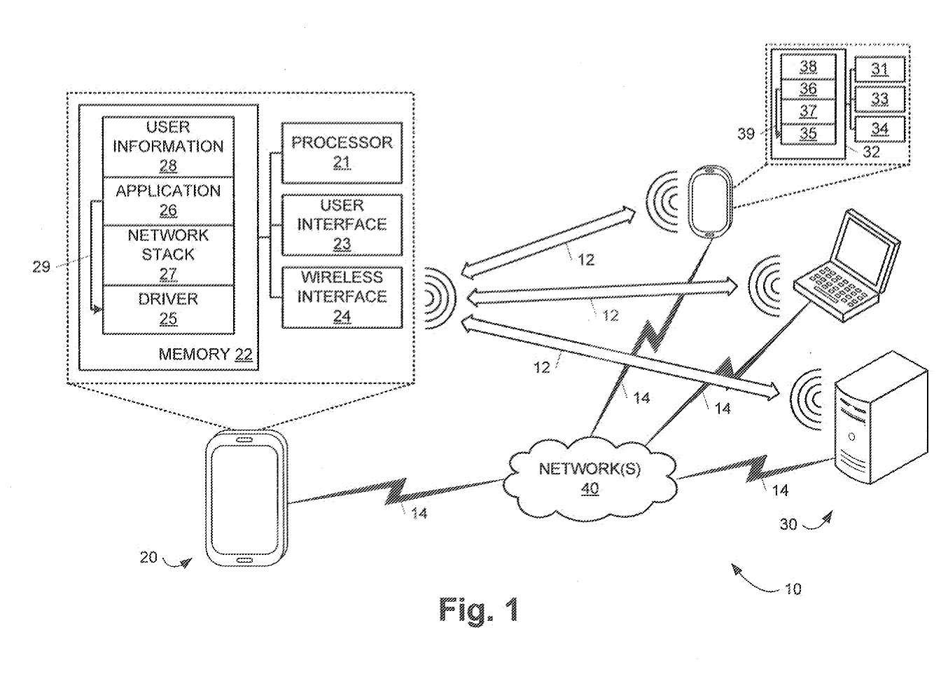

FIG. 1 is a block diagram illustrating one embodiment of a user information exchange environment 10. User information exchange environment 10 includes a user device 20 that is configured to wirelessly communicate with any number of other user devices 30. The wireless communications may include direct level 2 connections 12 between user device 20 and one or more of user device 30 and/or network connections 14 between user devices 20 and 30 and one or more networks 40. In addition to the wireless connections 12 and 14 shown in FIG. 1, one or more of user devices 20 and 30 may also include wired communications capabilities with networks 40 or other user devices.

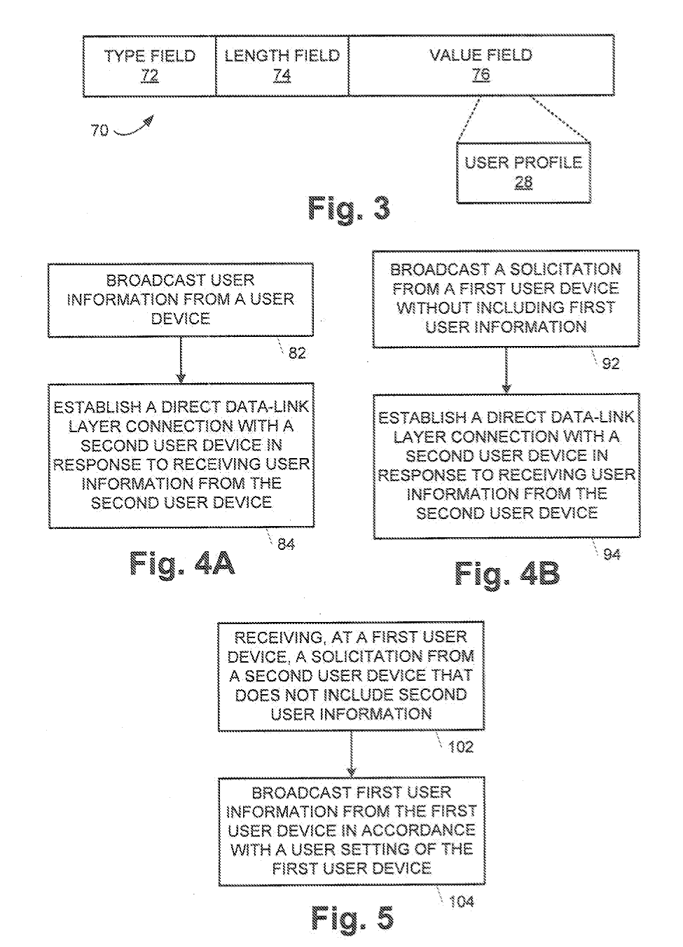

User information exchange environment 10 allows user information 28 stored on user device 20 and user information 38 stored on user devices 30 to be exchanged within a wireless communication range of wireless interfaces 24 and 34 of user devices 20 and 30, respectively. User information exchange environment 10 provides a User Specific Information-Element/Exchange (USIE) using Generic Advertisement Services (GAS) exchanges, as defined by the 802.11u networking standards promulgated by the Institute of Electrical and Electronics Engineers (IEEE), or customized packet frames for exchanging user information 28 and 38. User information 28 and 38 may be encoded or unencoded in a TLV (type-length-value) format according to one embodiment illustrated with reference to FIG. 3 and described in additional detail below.

User information 28 and 38 includes any suitable type and/or combination of information that identifies a user of a user device 20 or 30, respectively, such as a name, an address, a phone number, an email address, a social networking identifier (e.g., a Twitter, Facebook; or LinkedIn identifier), a business loyalty program identifier (e.g., a frequent flyer number or customer number), an affiliation, a membership, and/or a temporary or limited use identifier such as an electronic ticket (e-ticket), a boarding pass, or a time-limited access code.

The USIE may provide an optionally secure mechanism that allows users to select a security level from no security (i.e., unsolicited, unencrypted USIE broadcasts) to unicast responses only to verifiably signed, authorized, and encrypted solicitations with asymmetric encryption mechanisms on both solicit and USIE unicasts to address privacy concerns.

User device 20 comprises any suitable processing device configured for interaction with a user. A processing device may be a mobile telephone with processing capabilities (i.e., a smart phone), a digital still and/or video camera, a personal digital assistant (PDA), an audio/video device, or another suitable type of electronic device with processing capabilities. Processing capabilities refer to the ability of a device to execute instructions stored in a memory 22 with at least one processor 21. A processing device may also be a laptop computer, a tablet computer, or another suitable type of portable computer system.

User device 20 includes at least one processor 21 configured to execute machine readable instructions stored in a memory system 22, a user interface 23, and wireless interlace 24. Processors 21, memory 22, user interface 23, and wireless interface 24 communicate using a set of interconnections that includes any suitable type, number, and/or configuration of controllers, buses, interfaces, and/or other wired or wireless connections in user device 20.

User device 20 may execute a basic input output system (BIOS), firmware, an operating system, a runtime execution environment, and/or other services and/or applications stored in memory 22 (not shown) that includes machine readable instructions that are executable by processors 21 to manage the components of user device 20 and provide a set of functions that allow other programs to access and use the components.

Each processor 21 is configured to access and execute instructions stored in memory system 22. Each processor 21 may execute the instructions in conjunction with or in response to information received from user interface 23 and wireless interface 24. Each processor 102 is also configured to access and store data in memory system 22.

Memory system 22 includes any suitable type, number, and configuration of volatile or non-volatile storage devices configured to store instructions and data. The storage devices of memory system 22 represent computer readable storage media that store computer-readable and computer-executable instructions including a driver 25 for wireless interface 24, an application 26 that uses wireless interface 24 via driver 25, and a network stack 27. Memory system 22 stores instructions and data received from processors 21, memory 22, user interface 23, and wireless interface 24 and provides stored instructions and data to processors 21, memory 22, user interface 23, and wireless interface 24. Examples of storage devices in memory system 22 include hard disk drives, random access memory (RAM), read only memory (ROM), flash memory drives and cards, and other suitable types of magnetic and/or optical disks.

User interface 23 includes any suitable type, number, and/or combination of input and output devices configured to allow user inputs from a user to be entered into user device 20 and output information from user device 20 to the user. Examples of devices in user interface 23 include as display, a keyboard, a touchscreen, buttons, dials, knobs, switches, a mouse, and a touchpad.

Wireless interface 24 includes any suitable type, number, and/or configuration of wireless network devices configured to allow user device 20 to communicate with user devices 30 and/or networks 40 configured for wireless communication. Wireless interface 24 may operate according to any suitable wireless networking protocol and/or configuration to allow information to be transmitted by user device 20 to user devices 30 and/or networks 40 and received by user device 20 from user devices 30 and/or networks 40. Wireless communication between user devices 20 and 30 and between user devices 20 and 30 and network 40 is generally performed by modulating electromagnetic waves being transmitted at certain frequencies. Wireless network devices typically operate on either the 2.4 GHz frequency band or the 5 GHZ frequency band according to the 802.11 networking standards as defined by the Institute of Electrical and Electronics Engineers (IEEE). Future wireless network devices may operate on a 60 GHz frequency band (e.g., future 802.11 network devices), frequency bands between 400 Mhz and 800 MHz, or other suitable frequency bands.

Each user device 30 also comprises any suitable portable or non-portable processing device (including any of the processing devices listed above) configured for interaction with a user and includes features 31-38 (e.g., at least one processor 31, a memory system 32, etc.) that correspond to features 21-28 of user device 20, respectively, and perform the functions of respective features 21-28 described above. In some embodiments, one or more user devices 30 may be non-portable processing devices such as a desktop computer system, a server, or a printer.

Networks 40 each include any suitable type, number, and/combination of network devices configured to allow user devices 20 and 30 to establish connections 14 and communicate wirelessly. Connections 14 may vary by the type of user device 20 or 30 and the type of network 30. Networks 40 are typically identified by a Service Set Identifier (SSID). The user of user device 20 or 30 will typically select an available network by its SSID and enter a network password, if necessary, to establish a connection 14 to a network 40.

User devices 20 and 30 execute applications 26 and 36, respectively, to implement the USIE in one embodiment. In other embodiments, the USIE may be at least partially implemented by drivers 25 and 35. Although the following description refers to embodiments of application 26, embodiments of application 36, driver 25, or driver 35 may be configured to perform the functions of application 26 described herein.

Application 26 interacts with a user to configure user settings for the USIE using user interface 23. In particular, application 26 obtains user information 28 from the user by prompting the user to enter the information or, if permitted by the user, accessing the information from another processing device (e.g., accessing the information from a social networking website or other processing device that stores information about the user). In addition, the user settings of application 26 include the ability for the user to select the circumstances under which user information 28 is broadcast. For example, the user may select to broadcast user information 28 only at certain times or locations or only in response to certain types of solicitations from other user devices 30. In addition, application 26 may be configured to prompt the user when other user information 38 or solicitations for user information 28 are received to allow the user to decide whether to broadcast user information 28 in each instance. Application 26 further allows the user to select security user settings as described in additional detail below.

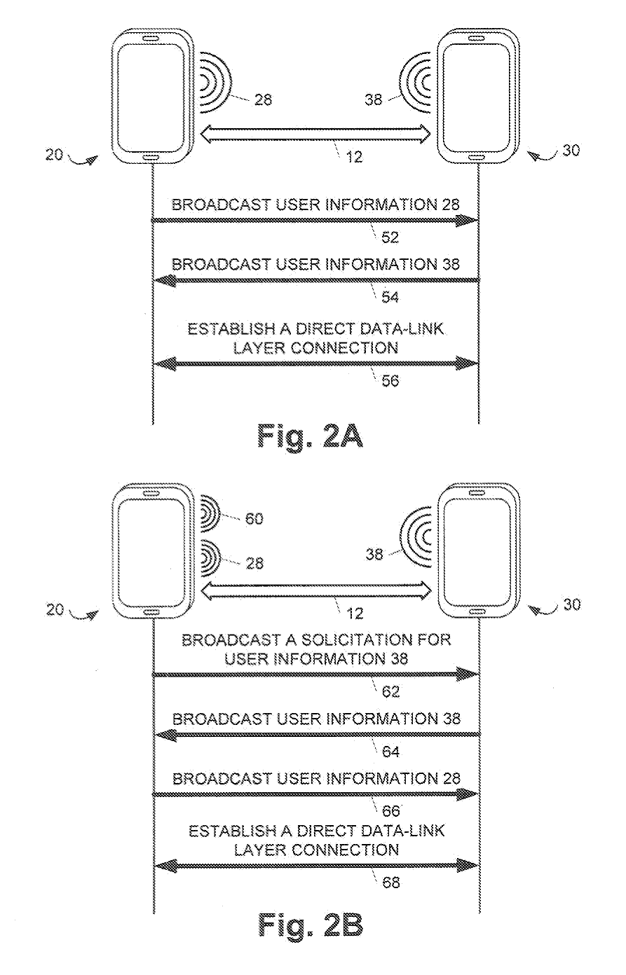

Application 26 broadcasts user information 28 and/or solicitations for user information 38 using wireless interface 24 in accordance with the user settings as described with reference to the embodiments of FIGS. 2A and 2B, which are schematic diagrams illustrating embodiments of USIEs between user devices 20 and 30.

In the embodiment of FIG. 2A, user device 20 broadcasts user information 28 for receipt by any user devices 30 within a wireless communication range of wireless interface 24 as indicated by an arrow 52. In response to receiving user information 28, a user device 30, in accordance with the user settings of the user device 30, may respond by broadcasting user information 38 as indicated by an arrow 54. Based on the exchange of user information 28 and 38, the users of user devices 20 and 30 may establish a direct data-link layer connection 12 as indicated by an arrow 56 to allow user devices 20 and 30 to communicate independently of any networks 40. Various scenarios in which user devices 20 and 30 may communicate are described in additional detail below.

In the embodiment of FIG. 2A, the user of either user device 20 or 30 may opt to prevent connection 12 from being established in response to receiving user information 38 or 28, respectively. For example, a user may choose to ignore received user information 28 or 38 or choose to deny a request to establish connection 12. The choice of allowing or preventing a connection 12 may occur automatically in response to user settings in user devices 20 and 30 where the users have opted to automatically permit or prevent connections 12 to be formed.

Although the embodiment of FIG. 2A illustrates a single user device 30 responding to user information 28 and establishing a connection 12 with user device 20, other user devices 30 may also respond to and/or establish additional connections 20 in response to the same broadcast of user information 28.

In the embodiment of FIG. 2B, user device 20 broadcasts a solicitation 60 for user information 38 for receipt by any user devices 30 within a wireless communication range of wireless interface 24 as indicated by an arrow 62. The broadcast solicitation requests user information 38 without including user information 28. In response to receiving solicitation 60, a user device 30, in accordance with the user settings of the user device 30, may respond by broadcasting user information 38 as indicated by an arrow 64. User device 20, in response to receiving user information 38, may respond by broadcasting user information 28 as indicated by an arrow 66. Based on the exchange of user information 28 and 38, the users of user devices 20 and 30 may establish a direct data-link layer connection 12 as indicated by an arrow 68 to allow user devices 20 and 30 to communicate independently of any networks 40.

As with the embodiment of FIG. 2A, the user of either user device 20 or 30 may opt to prevent connection 12 from being established in response to receiving user information 38 or 28, respectively, in the embodiment of FIG. 2B. Further, the choice of allowing or preventing a connection 12 may occur automatically in response to user settings in user devices 20 and 30 where the users have opted to automatically permit or prevent connections 12 to be formed.

Although the embodiment of FIG. 2B illustrates a single user device 30 responding to solicitation 60 and establishing a connection 12 with user device 20, other user devices 30 may also respond to and/or establish additional connections 20 in response to the same broadcast of user information 28.

In the embodiments of FIGS. 2A-2B, the exchange of user information 28 and 38 between user devices 20 and 30 may be performed using Generic Advertisement Services (GAS) exchanges or customized packet frames. Customized packet frames may be structured specifically for applications 26 and 36 in some embodiments.

Referring back to FIG. 1, the establishment of a direct data-link layer connection 12 between user devices 20 and 30 will now be described. To establish connection 12, application 26 opens a socket on network stack 27. Application 26 also notifies driver 25 that data transferred over this socket has a L2 broadcast or multicast group destination as indicated by an arrow 29. (Application 36 in user device 30 performs as similar function as indicated by an arrow 39.) Application 26 may, in some embodiments, use existing enable and disable function mechanisms of a networking standard to communicate with driver 25 and enable the direct data-link layer connection 12. Application 26 provides data to driver 25 using the socket on network stack 27, and driver 25 identifies the direct data-link layer connection 12 as the destination and transmits the data directly to user device 30.

By establishing and using direct data-link layer connection 12, user device 20 may transmit data to and receive data from user device 30 without associating with a network 40 (i.e., without performing an authentication protocol, such as an exchange of link-level authentication frames, association frames, or optional higher level WPS, WPA, WPA, or PSK/enterprise frames). The direct data-link layer connection 12 essentially creates a new network between only user device 20 and user device 30 that is structured as a peer-to-peer setup rather than a client/server setup. User device 20 may also maintain an existing connection 14 to a network 40 while communicating with user device 30 using the direct data-link layer connection 12. This may occur because the direct data-link layer connection 12 uses a different socket of network stack 27 than the socket that is associated with the network 40.

Various security protocols may be implemented in applications 26 and 36 to allow users to select a security level from no security (i.e., unsolicited, unencrypted USIE broadcasts) to broadcast responses only to verifiably signed, authorized, and encrypted solicitations with asymmetric encryption mechanisms (e.g., public and private keys) on both solicit and USIE broadcasts to address privacy concerns.

FIG. 3 is a block diagram illustrating one embodiment of a Type-Length-Value (TLV) network packet 70 that includes user information 28. In some embodiments, the protocols involved in the direct level 2 connection 12 between user devices 20 and 30 may use TLV network packet 70. TLV elements are used to encode data within a protocol. A TLV element includes a type field 72, a length field 74, and a value field 76. The type field 72 is typically a fixed sequence of bits that defines the type of data within packet 70. The length field 74 identifies the length of the value of packet 70. The value field 76 is of a length indicated by the length field 76 and includes a set portion of the data to be transmitted such as user information 28 (or user information 38 for packets 70 generated by user devices 30 (not shown).

In other embodiments, other types of network, packets may be used to include user information 28 such as packets with fixed sizes and pre-determined locations for user information 28.

FIG. 4A is a flow chart illustrating an embodiment of a method for establishing direct data-link layer connection 12 between user devices 20 and 30. Although the method of FIG. 4A will be described primarily with reference to user device 20, the roles of user device 20 and user device 30 may be reversed in other embodiments where user device 30 performs the functions shown in FIG. 4A.

In FIG. 4A, user device 20 broadcasts user information 28 using wireless interface 24 as indicated in a block 82. User device 20 broadcasts user information 28 in accordance with user settings as described above. User device 20 establishes a direct data-link layer connection 12 with a user device 30 using wireless interface 24 in response to receiving user information 38 from the user device 30 as indicated in a block 84. User device 20 may transmit data to user device 30 subsequent to establishing the direct data-link layer connection 12 using TLV network packets 70 (shown in FIG. 3) in one embodiment. User device 20 may also maintain a network connection 14 with a network 40 subsequent to establishing the direct data-link layer connection 12.

FIG. 4B is a flow chart illustrating an embodiment of a method for establishing direct data-link layer connection 12 between user devices 20 and 30. Although the method of FIG. 4B will be described primarily with reference to user device 20, the roles of user device 20 and user device 30 may be reversed in other embodiments where user device 30 performs the functions shown in FIG. 4B.

In FIG. 4B, user device 20 broadcasts a solicitation without including user information 28 using wireless interface 24 as indicated in a block 92. User device 20 broadcasts the solicitation to request user information 38 from user device 30. User device also 20 broadcasts the solicitation in accordance with user settings as described above. User device 20 establishes a direct data-link layer connection 12 with a user device 30 using wireless interface 24 in response to receiving user information 38 from the user device 30 as indicated in a block 92. User device 20 may provide user information 28 to user device 30 in response to receiving user information 38 prior to the connection 12 being established. User device 20 may also transmit data to user device 30 subsequent to establishing the direct data-link layer connection 12 using TLV network packets 70 (shown in FIG. 3) in one embodiment. User device 20 may also maintain a network connection 14 with a network 40 subsequent to establishing the direct data-link layer connection 12.

FIG. 5 is a flow chart illustrating an embodiment of a method for broadcasting user information 28 in response to a solicitation. Although the method of FIG. 5 will be described primarily with reference to user device 20, the roles of user device 20 and user device 30 may be reversed in other embodiments where user device 30 performs the functions shown in FIG. 5.

In FIG. 5, user device 20 receives a solicitation from user device 30 that does not include user information 38 using wireless interface 24 as indicated in a block 102. User device 20 broadcasts user information 28 using wireless interface 24 in accordance with a user setting of user device 20 (e.g., a user setting that indicates whether to broadcast user information 28 in response to a solicitation) as indicated in a block 104. User device 20 may subsequently establish a direct data-link layer connection 12 with a user device 30 using wireless interface 24 in response to receiving user information 38 from the user device 30. User device 20 also transmit data to user device 30 subsequent to establishing the direct data-link layer connection 12 using TLV network packets 70 (shown in FIG. 3) in one embodiment. User device 20 may also maintain a network connection 14 with a network 40 subsequent to establishing the direct data-link layer connection 12.

The above embodiments may enable wireless user discovery and location-based social networking interaction, targeted service delivery, and service logistics management.

By enabling wireless user discovery and location-based social networking interaction, a user may use the above embodiments to discover and identify other nearby users. The other users may be social network friends of the user, as recognized by a user name or other identifier, or others with a shared affiliation, or those who have a commonality determined from the exchanged user information.

The above embodiments may also enable various targeted service delivery scenarios. For example, airport personnel can determine whether a user device is broadcasting user information in a particular part of the airport and deliver personalized services to the user. Casinos may deliver surprise gifts to users broadcasting user information who spend a long amount of time near slot machines. Convenience stores may deliver coupons to users based on the frequency of visits to a store determined from broadcast user information detected over time. A taxi driver may broadcast user information to announce availability to be hired, or a user seeking a taxi could broadcast user information indicating a location and a desire for a taxi. Also, businesses could broadcast user information that announces product information, provides coupons, or solicits orders.

In addition, the above embodiments may also enable various service logistics management scenarios. The embodiments may provide personnel management based on locations of service providers (e.g., by tracking service personnel in selected areas who broadcast user information). The embodiments may also track the location of users who broadcast user information to provide client management based on the location of clients. For example, airport announcements and paging may be targeted only to loudspeakers near broadcasting users instead of on loudspeakers throughout the airport. Further, broadcast user information may be used to manage the temporary use of resources. Business may use broadcast user information to allow or restrict access to certain areas or resources (e.g., printers). A business may provide a user with a temporary code or identifier to broadcast as part of the user information where the code provides access to certain areas or resources. Once a code expires, security personnel may use the broadcast code to track the location of a user.

Because the USIE described above allows user devices to communicate across a direct data-link layer connection, the above embodiments may be implemented independently of an Internet Service Provider (ISP) or other network infrastructure. Accordingly, the USIE may continue to operate during infrastructure failures, including those that occur as a result of a natural disaster.

Given that the range of personal networks continues to increase (e.g., TVWS spectrum has a maximum range of in the tens of kilometers), USIE may allow unique identification mechanisms of network users over a wide area. Once user is identified, users may communicate over the direct data-link layer connection (including voice and/or video communication) to reduce charges from the use of cellular telephone networks.

Although specific embodiments have been illustrated and described herein for purposes of description of the embodiments, it will be appreciated by those of ordinary skill in the art that a wide variety of alternate and/or equivalent implementations may be substituted for the specific embodiments shown and described without departing from the scope of the present disclosure. Those with skill in the art will readily appreciate that the present disclosure may be implemented in a very wide variety of embodiments. This application is intended to cover any adaptations or variations of the disclosed embodiments discussed herein. Therefore, it is manifestly intended that the scope of the present disclosure be limited by the claims and the equivalents thereof.

What is claimed is:

1. A method performed by a first user device, the method comprising:
broadcasting first user information using a wireless interface of the first user device; and
establishing a direct data-link layer connection with a second user device using the wireless interface in response to receiving second user information from the second user device.

2. The method of claim 1, wherein the connection comprises use of at least one of Generic Advertising Service (GAS) exchanges or customized network packets.

3. The method of claim 1, wherein the first user device is one of a smart phone, a tablet computer, or a laptop computer.

4. The method of claim 1, further comprising:
prompting a user of the first user device to enter the first user information.

5. The method of claim 1, further comprising:
allowing a user of the first user device to enter a security user setting.

6. The method of claim 1, further comprising:
transmitting data to the second user device subsequent to establishing the direct data-link layer connection.

7. The method of claim 6, further comprising:
transmitting the data using a Type Length Value (TLV) network packet.

8. The method of claim 6 further comprising:
maintaining a network connection with a network subsequent to establishing the direct data-link layer connection.

9. A first user device comprising:
a memory to store a set of instructions and first user information; and
a processor to execute the set of instructions to:
broadcast a solicitation using a wireless interface of the first user device, the solicitation requesting second user information from a second user device without including the first user information; and
establishing a first connection with the second user device using the wireless interface in response to receiving the second user information directly from the second user device.

10. The processing system claim 9 wherein the processor is to execute the set of instructions to broadcast the first user information in response to receiving the second user information.

11. The processing system claim 9 wherein the processor is to execute the set of instructions to transmit data to the second user device subsequent to establishing the first connection.

12. The processing system claim 11 wherein the processor is to execute the set of instructions to maintain a second connection with a network subsequent to establishing the first connection.

13. A computer readable storage medium storing instructions that, when executed by a first user device, perform a method comprising:
receiving a broadcast solicitation from a second user device using a wireless interface of the first user device, the broadcast solicitation requesting first user information from the first user device without including second user information from the second user device; and
broadcasting the first user information using the wireless interface of the first user device in accordance with a user setting of the first user device.

14. The computer readable storage medium of claim 13, the method further comprising:
subsequent to broadcasting the first user information, receiving second user information from the second user device; and
establishing a connection with the second user device in response to receiving the second user information.

15. The computer readable storage medium of claim 14, wherein the user setting indicates whether to broadcast the first user information in response to the solicitation.
